(19) United States
(12) Patent Application Publication
(10) Pub. No.: US 2005/0071807 A1
(43) Pub. Date: Mar. 31, 2005

(54) Methods and systems for predicting software defects in an upcoming software release

(76) Inventor: Aura Yanavi, Clifton, NJ (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/718,400

(22) Filed: Nov. 20, 2003

Related U.S. Application Data
(60) Provisional application No. 60/506,794, filed on Sep. 29, 2003.

(51) Int. Cl. G06F 9/44

(52) U.S. Cl. 717/104; 717/124; 717/101

(57) ABSTRACT

The present invention provides a novel way to forecast the number of software defects for an upcoming software release. The systems and methods of the present invention involve evaluating the relative size of the upcoming software release with respect to a baseline software release, and estimating the number of expected defects based on the relative size of the upcoming software release and the number of observed software defects for the baseline release. Additional robustness may be achieved by adjusting the forecast to take into consideration regression defects that were detected in the baseline release as well as any code re-factoring. The present invention may be used in various applications such a project management system to allow a project manager to allocate sufficient resources to handle software defects, and to plan accordingly. In various embodiments, a metric is provided to measure the quality achieved after product implementation, based on the forecasted number of software defects.

### CROSS REFERENCE TO RELATED APPLICATIONS

This application claims the benefit of U.S. Provisional Application Ser. No. 60/506,794, filed by Aura Yanavi on Sep. 29, 2003 and entitled “Methods and Systems For Predicting Software Defects In an Upcoming Software Release”, which is incorporated herein by reference.

### FIELD OF THE INVENTION

The present invention relates generally to software engineering, and, more particularly, to methods and systems for predicting software defects in an upcoming software release.

### BACKGROUND OF THE INVENTION

In an effort to improve software quality, various project management systems have been developed. Although these project management systems improve the chances that projects will be completed in a timely manner, managers continue to find it difficult to predict the number of software defects for upcoming software releases. If the number of software defects could be reliably predicted, then managers would be able to commit the necessary resources to more accurately deal with problems that arise.

In the academic world, this area of software defect prediction has been the subject of considerable research. There are complex, quantitative methods that focus on the relationship between the number of defects and software complexity. Typically, these models make numerous, unrealistic assumptions. Still other models focus on the quality of the development process as the best predictor of a product's quality. Unfortunately, none of these approaches have yielded accurate results. Accordingly, it would be desirable and highly advantageous to provide improved and simplified techniques for predicting software defects.

### SUMMARY OF THE INVENTION

The present invention provides a novel way to forecast the number of software defects for an upcoming software release. According to the methods and systems of the present invention, the relative size of an upcoming software release with respect to a baseline software release is determined, and the number of software defects for the upcoming software release is forecast based on the relative size of the upcoming software release and the number of observed software defects for the baseline software release. The relative size of the upcoming software release can be obtained by determining the number of new test requirements for the upcoming software release, determining the number of test requirements for the baseline software release, and dividing the number of new test requirements for the upcoming software release by the number of test requirements for the baseline software release. The forecasted number of software defects can be then be calculated by multiplying the number of observed software defects for the baseline software release by the relative size of the upcoming software release.

According to an embodiment of the invention, a quality measurement for the upcoming software release can be determined based on the actual number of software defects for the upcoming software release relative to the forecasted number of software defects for the upcoming software release. This quality measurement value can be calculated by dividing the forecasted number of software defects by the actual number of software defects. A quality measurement value greater than one indicates that the software release achieved higher quality than the baseline software release. A quality measurement value of one indicates that the software release achieved the same level of quality as the baseline software release. A quality measurement value less than one indicates that the software release has a lower quality level than the baseline software release.

According to another embodiment of the invention, the forecasting step includes multiplying the number of observed software defects for the baseline software release by the sum of the relative size of the upcoming software release and a regression defect factor.

According to another embodiment of the invention, the forecasting step includes multiplying the number of observed software defects for the baseline software release by the sum of the relative size of the upcoming software release and a refactoring factor.

According to another embodiment of the invention, aspects of the present invention are incorporated into a project management system.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a computer processing system to which the present invention may be applied according to an embodiment of the present invention;

FIG. 2 shows a flow diagram outlining an exemplary technique for forecasting the number of software defects for an upcoming software release; and

FIG. 3 shows an exemplary screen display of a project management system incorporating the software defect prediction features of the present invention.

### DESCRIPTION PREFERRED EMBODIMENTS

The present invention provides a technique to forecast the number of software defects for an upcoming software release that involves evaluating the relative size of the upcoming software release with respect to a baseline software release, and estimating the number of expected defects based on the relative size of the upcoming software release and the number of observed software defects for the baseline software release. In various embodiments, a metric is provided to measure the quality achieved after product implementation.

It is to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed.

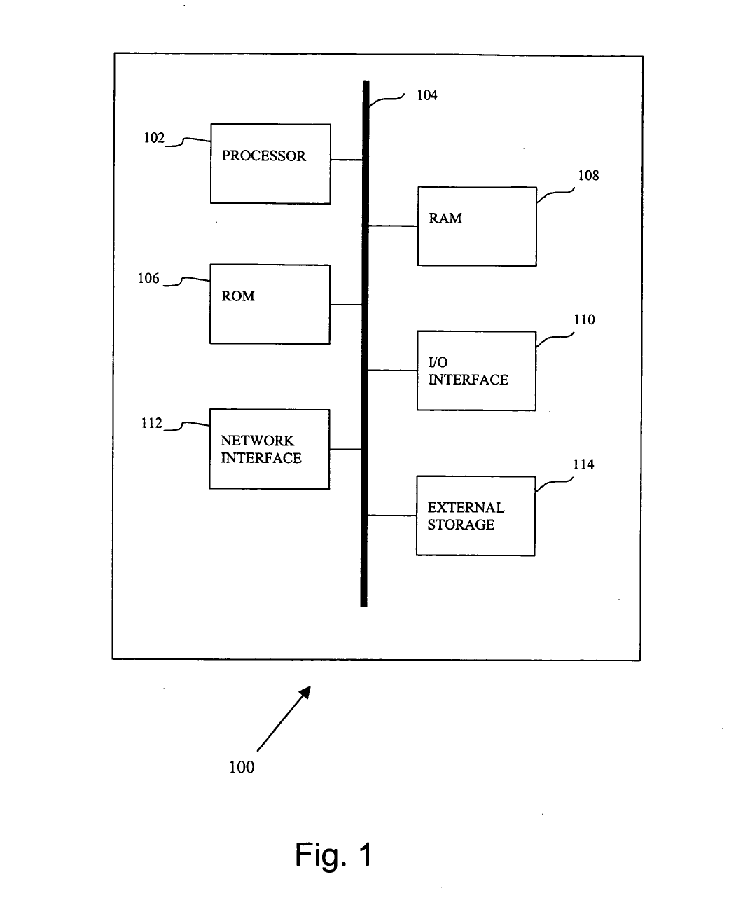

FIG. 1 is a block diagram of a computer processing system 100 to which the present invention may be applied according to an embodiment of the present invention. The system 100 includes at least one processor (hereinafter processor) 102 operatively coupled to other components via a system bus 104. A read-only memory (ROM) 106, a random access memory (RAM) 108, an I/O interface 110, a network interface 112, and external storage 114 are operatively coupled to the system bus 104. Various peripheral devices such as, for example, a display device, a disk storage device(e.g., a magnetic or optical disk storage device), a keyboard, and a mouse, may be operatively coupled to the system bus 104 by the I/O interface 110 or the network interface 112.

The computer system 100 may be a standalone system or be linked to a network via the network interface 112. The network interface 112 may be a hard-wired interface. However, in various exemplary embodiments, the network interface 112 can include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and the Internet.

The external storage 114 may be implemented using a database management system (DBMS) managed by the processor 102 and residing on a memory such as a hard disk. However, it should be appreciated that the external storage 114 may be implemented on one or more additional computer systems.

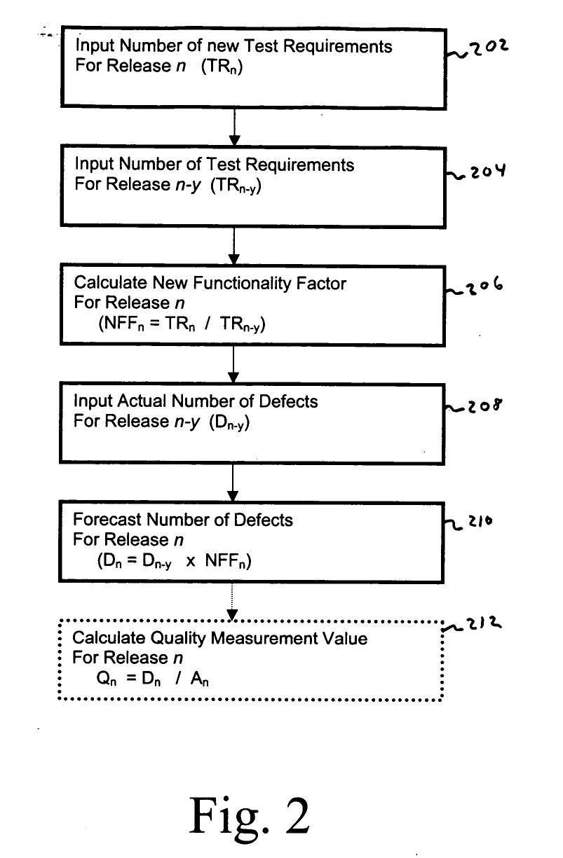

FIG. 2 is a flow diagram illustrating an exemplary technique for predicting the number of software defects in an upcoming software release.

In step 202, the number of new test requirements for a software release (TRₙ) is input. In general, a test requirement can include any software feature that will be the subject of testing. The test requirements will generally have been determined during the course of project planning. For example, many project management systems employ function point analysis. Function point analysis requires a project manager to estimate the number of software features that will be needed for a software system. The time necessary to develop the project is taken as the sum of the development time for each feature of the software. In this case, the number of new functions to be implemented could be used as the number of test requirements for the upcoming software release. This value could be manually input, or obtained directly from the project management system, for example.

Next, in step 204, the number of test requirements for a baseline software release (TR_{n-y}) is determined. Generally, this “baseline release” will be a major software release, whereas the upcoming release will include relatively fewer new features. In the software industry, major releases are often designated by a whole number such as “Release 2.0”. Minor releases are often designated with a decimal value, such as “Release 2. 1”. The number of test requirements for the baseline release will generally be a known quantity.

In step 206, the New Functionality Factor for the upcoming release is calculated The following formula specifies one way to determine the New Functionality Factor:
NFFₙ=TRₙ/TR_{n-y} (1)
where
NFFₙ is the New Functionality Factor for release n;
TRₙ is the number of new test requirements for release n; and
TRₙ is the number of test requirements for release n-y, where y=1, . . . m-1, and y<n.

Next, in step 208, the actual number of defects for the baseline release (D_{n-y}) is input. In general, this will be a known value and will reflect defects that have so far been observed. Defects could include critical defects, major defects, minor defects, etc. However, it is important that the type of defect counted in this step be of the type that the user wishes to have forecast. Thus, if only critical defects were to be forecasted, then the value for D_{n-y} should only include observed critical defects for the baseline release.

Next, in step 210, the number of defects for the upcoming software release (Dₙ) is calculated. One way to calculate the number of defects is to use the following formula:
Dₙ=D_{n-y}*NFFₙ (2)
where
Dₙ is the estimated number of defects for release n,
D_{n-y} is the number of observed software defects for release n-y, and
NFFₙ is the New Functionality Factor (determined in Formula 1) for release n.

Finally, it may be desirable to measure the quality of the new software release. In step 212, a quality measurement value (Qₙ) can optionally be determined after product implementation, using the following formula:
Qₙ=Dₙ/Aₙ (3)
where
Qₙ is the quality measurement value,
Dₙ is the estimated number of defects for release n, and
Aₙ is the actual number of defects for release n.

The quality measurement value (Qₙ) may be interpreted as shown in Table 1.

TABLE 1
Interpretation of Quality Measurement Value

| | |
|---|---|
| Qₙ < 1 | Release n is of lower quality than the |
| | baseline release |
| Qₙ = 1 | Release n has the same quality as the |
| | baseline release |
| Qₙ > 1 | Release n is of higher quality than the |
| | baseline release |

Although the method described above, with reference to FIG. 2, is a relatively straightforward technique to forecast the number of software defects, it is to be appreciated that variations to the above formula(s) may be made without departing from the spirit and scope of the present invention.

The following will now describe additional ways in which the basic methodology may be expanded to create a more robust tool.

As discussed above, the New Functionality Factor (NFFₙ) may be determined by dividing the number of new test requirements for an upcoming software release by the number of test requirements for a “benchmark” software release. However, this assumes that all defects are discovered only in the a new functionality. We can overcome this assumption by taking into account the factor of actual regression defects (R) (percentage of actual regression defects divided by 100) in the release that we are using as the benchmark. The following formula may be used in lieu of Formula 2 to calculate the estimated number of defects in an upcoming software release, taking into consideration regression defects.
Dₙ=D_{n-y}*(NFFₙ+R_{n-y}) (4)
where
R_{n-y} is the percentage of actual regression defects divided by 100.

The present invention can also be used in the situation where software code is re-factored. Software code is refactored when it is substantially re-written. We can overcome the problem of code re-factoring by adding the value “1” (or another suitable value) to the New Functionality Factor for that release. This means that we expect regression defects across the functionality as a benchmark. (If the regression defects were expected across 80% of the functionality, then the value “0.80” could be added to the New Functionality Factor). The following formula expresses this concept (where the assumption is that regression defects will be across all functionalities).
Dₙ=D_{n-y}*(NFFₙ+1) (5)

The invention will be clarified by the following examples.

### EXAMPLE 1

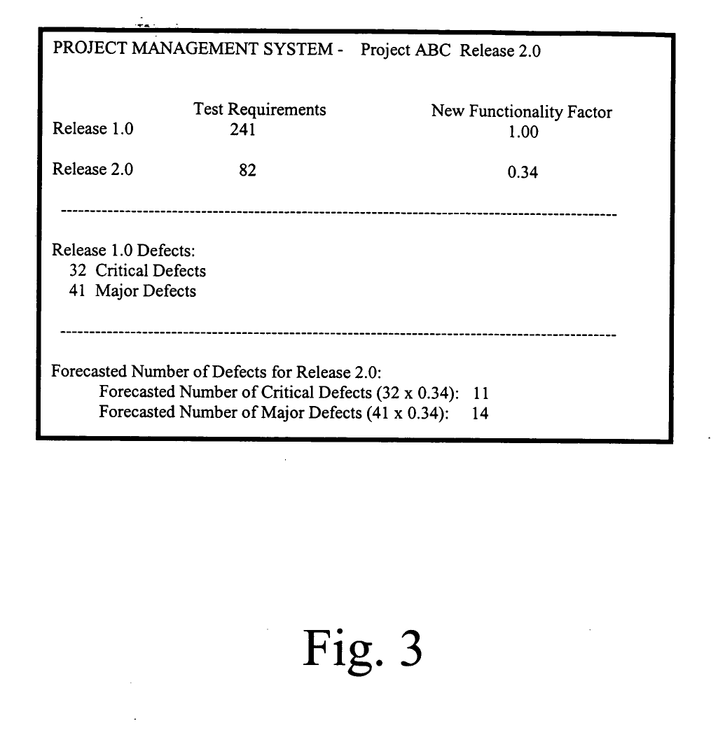

FIG. 3 illustrates an exemplary screen display of a project management system incorporating features of the present invention. As depicted in FIG. 3, a baseline release (“Release 1.0”) had 241 test requirements, and an upcoming software release (“Release 2.0”) had 82 new test requirements. Applying Formula 1, the New Functionality Factor was calculated, as follows:
NFFₙ=241/82=0.34

As indicated, Release 1.0 had 32 Critical Defects and 41 Major Defects.

Applying Formula 2, the estimated number of critical defects for Release 2.0 was calculated as follows:
Dₙ=(32*0.34)=11

Applying Formula 2, the estimated number of major defects for Release 2.0 was calculated as follows:
Dₙ=(41*0.34)=14

### EXAMPLE 2

Suppose, after implementation of Release 2.0, there were actually 10 critical defects and 12 major defects. Using the estimated number of software defects from Example 1 and applying Formula 3, the quality measurements would be calculated as follows:
Qₙ=11/10=1.10 (critical defect quality)
Qₙ=14/12=1.67 (major defect quality).
In this case, the project achieved slightly higher critical defect quality and major defect quality than the baseline.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A method for predicting the number of software defects for an upcoming software release, comprising the steps of:
determining the relative size of the upcoming software release with respect to a baseline software release; and
forecasting the number of software defects for the upcoming software release based on the relative size of the upcoming software release and the number of observed software defects for the baseline software release.

2. The method of claim 1, wherein determining the relative size of the upcoming software release includes the steps of:
determining the number of new test requirements for the upcoming software release;
determining the number of test requirements for the baseline software release; and
dividing the number of new test requirements for the upcoming software release by the number of test requirements for the baseline software release.

3. The method of claim 1, wherein the forecasting step includes multiplying the number of observed software defects for the baseline software release by the relative size of the upcoming software release.

4. The method of claim 1, wherein the forecasting step includes multiplying the number of observed software defects for the baseline software release by the sum of the relative size of the upcoming software release and a regression defect factor.

5. The method of claim 1, wherein the forecasting step includes multiplying the number of observed software defects for the baseline software release by the sum of the relative size of the upcoming software release and a refactoring factor.

6. The method of claim 1, further including determining a quality measurement for the upcoming software release based on the actual number of software defects for the upcoming software release relative to the forecasted number of software defects for the upcoming software release

7. The method of 6, wherein the quality measurement is used by a project management system.

8. The method of claim 1, wherein number of software defects for the upcoming software release is used by a project management system.

9. The method of claim 1, wherein information used to forecast the software defects is graphically depicted.

10. The method of claim 1, wherein the baseline software release is selected by a user.

11. A system for predicting the number of software defects for an upcoming software release, comprising:
an input device for obtaining information regarding an upcoming software release and a baseline software release;
a processor for determining the relative size of the upcoming software release with respect to a baseline software release and forecasting the number of software defects for the upcoming software release based on the relative size of the upcoming software release and the number of observed software defects for the baseline software release; and
an output device for outputting the forecasted number of software defects for the upcoming software release.

12. The system of claim 11, wherein the information obtained by the input device includes the number of new test requirements for the upcoming software release and the number of test requirements for the baseline software release, and the processor determines the relative size of the upcoming software release by dividing the number of new test requirements for the upcoming software release by the number of test requirements for the baseline software release.

13. The system of claim 11, wherein the processor forecasts the number of software defects for the upcoming software release by multiplying the number of observed software defects for the baseline software release by the relative size of the upcoming software release.

14. The system of claim 11, wherein the processor forecasts the number of software defects for the upcoming software release by multiplying the number of observed software defects for the baseline software release by the sum of the relative size of the upcoming software release and a regression defect factor.

15. The system of claim 11, wherein the processor forecasts the number of software defects for the upcoming software release by multiplying the number of observed software defects for the baseline software release by the sum of the relative size of the upcoming software release and a refactoring factor.

16. The system of claim 11, wherein the processor further determines a quality measurement for the upcoming software release based on the actual number of software defects for the upcoming software release relative to the forecasted number of software defects for the upcoming software release

17. The system of 16, wherein the quality measurement is used by a project management system.

18. The system of claim 11, wherein number of software defects for the upcoming software release is used by a project management system.

19. The system of claim 11, wherein the output device is configured to graphically depict information regarding the forecasted number of software defects.

20. The system of claim 11, wherein the input device is configured to allow a user to select the baseline software release.

21. A program storage device readable by a machine, tangibly embodying a program of instructions executable on the machine to perform method steps for predicting the number of software defects for an upcoming software release, the method steps comprising:
determining the relative size of the upcoming software release with respect to a baseline software release; and
forecasting the number of software defects for the upcoming software release based on the relative size of the upcoming software release and the number of observed software defects for the baseline software release.

22. The program storage device of claim 21, wherein the instructions for performing the step of determining the relative size of the upcoming software release includes instructions for performing the steps of:
determining the number of new test requirements for the upcoming software release;
determining the number of test requirements for the baseline software release; and
dividing the number of new test requirements for the upcoming software release by the number of test requirements for the baseline software release.
